(19) United States
(12) Patent Application Publication
(10) Pub. No.: US 2001/0040833 A1
(43) Pub. Date: Nov. 15, 2001

(54) METHOD AND APPARATUS FOR SELF TIMING REFRESH

(76) Inventors: ZOHAR BOGIN, FOLSOM, CA (US); DAVID D LENT, PLACERVILLE, CA (US); VINCENT VON BOKERN, RESCUE, CA (US)

Correspondence Address: MICHAEL J MALLIE, BLAKELY SOKOLOFF TAYLOR & ZAFMAN, 12400 WILSHIRE BOULEVARD, 7TH FLOOR, LOS ANGELES, CA, 90025

(21) Appl. No.: 09/205,086

(22) Filed: Dec. 4, 1998

(51) Int. Cl. G06F 12/00

(52) U.S. Cl. 365/222; 711/106; 711/167

(57) ABSTRACT

According to one embodiment, the present invention discloses a computer system that includes a memory and a memory controller. The memory controller includes a refresh timing circuit that generates clock pulses. The clock pulses are used to trigger memory refresh events. According to a further embodiment, the refresh timing circuit includes a clock generator, a counter coupled to the clock generator and a storage register coupled to the clock generator and counter. Further, the refresh timing circuit includes a comparator coupled to the clock generator, the counter and the storage register.

### FIELD OF THE INVENTION

The present invention relates to memory systems; more particularly, the present invention relates to triggering refreshes in a memory system.

### BACKGROUND OF THE INVENTION

Mobile computer systems are capable of shutting down power to most of its subsystems while maintaining the content of the memory. This provides a mobile computer with a low power mode that enables power conservation. The low power mode may be entered following a period of inactivity while the computer is powered up. From the low power mode, the mobile computer can quickly resume complete system operation. While operating in the low power mode, the main memory must be periodically refreshed to recharge electrical cells in order to maintain data integrity. Accordingly, a system memory controller within the computer system typically refreshes the main memory while the computer is operating in the low power mode.

FIG. 1 is a block diagram of an exemplary computer system 100. Computer system 100 includes processor 105 coupled to processor bus 110. Processor 105 is also coupled to memory controller 120. Main memory 113 is coupled to processor bus 110 through memory controller 120. Main memory 113 stores sequences of instructions that are executed by processor 105. Processor bus 110 is also coupled to a Peripheral Component Interconnect (PCI) standard bus 130 by memory controller 120. Bus bridge 140 couples PCI bus 130 to an Industry Standard Architecture (ISA) bus 150.

Memory controller 120 is also coupled to bus bridge 140 via a power status line (STAT) and an external clock source (PDRCLK). A STAT signal is transmitted from bus bridge 140 to memory controller 120 in order to indicate whether computer system 100 is in the low power mode. PDRCLK provides a clock source to memory controller 120 during the low power mode in order to provide a reference for triggering main memory refreshes.

One problem with typical computer systems such as computer system 100 is that providing an external clock source, such as PDRCLK, to trigger a memory refresh requires an additional pin to be used at memory controller 120. The presence of additional pins at memory controller 120 may potentially lead to an increase in circuit complexity within computer system 100. Further, additional pins may result in an increase in the cost of manufacturing memory controller 120. Therefore, it would be desirable to provide a memory controller with an internal clock source for triggering a memory refresh.

### SUMMARY OF THE INVENTION

According to one embodiment, the present invention discloses a computer system that includes a memory and a memory controller. The memory controller includes a refresh timing circuit that generates clock pulses. The clock pulses are used to trigger memory refresh events.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 is a block diagram of an exemplary embodiment of a computer system.

FIG. 2 is a block diagram of one embodiment of a computer system in accordance with one embodiment of the present invention.

FIG. 3 is a memory controller in accordance with one embodiment of the present invention.

FIG. 4 is a block diagram of refresh timing unit in accordance with one embodiment of the present invention.

FIG. 5 is a flow diagram of the operation of a refresh timing unit in accordance with one embodiment of the present invention.

FIG. 6 is a flow diagram of the operation of a refresh timing unit in accordance with one embodiment of the present invention.

FIG. 7 is a block diagram of refresh timing unit in accordance with one embodiment of the present invention; and

FIG. 8 is a block diagram of an internal clock generator in accordance with one embodiment of the present invention.

### DETAILED DESCRIPTION OF THE PRESENT INVENTION

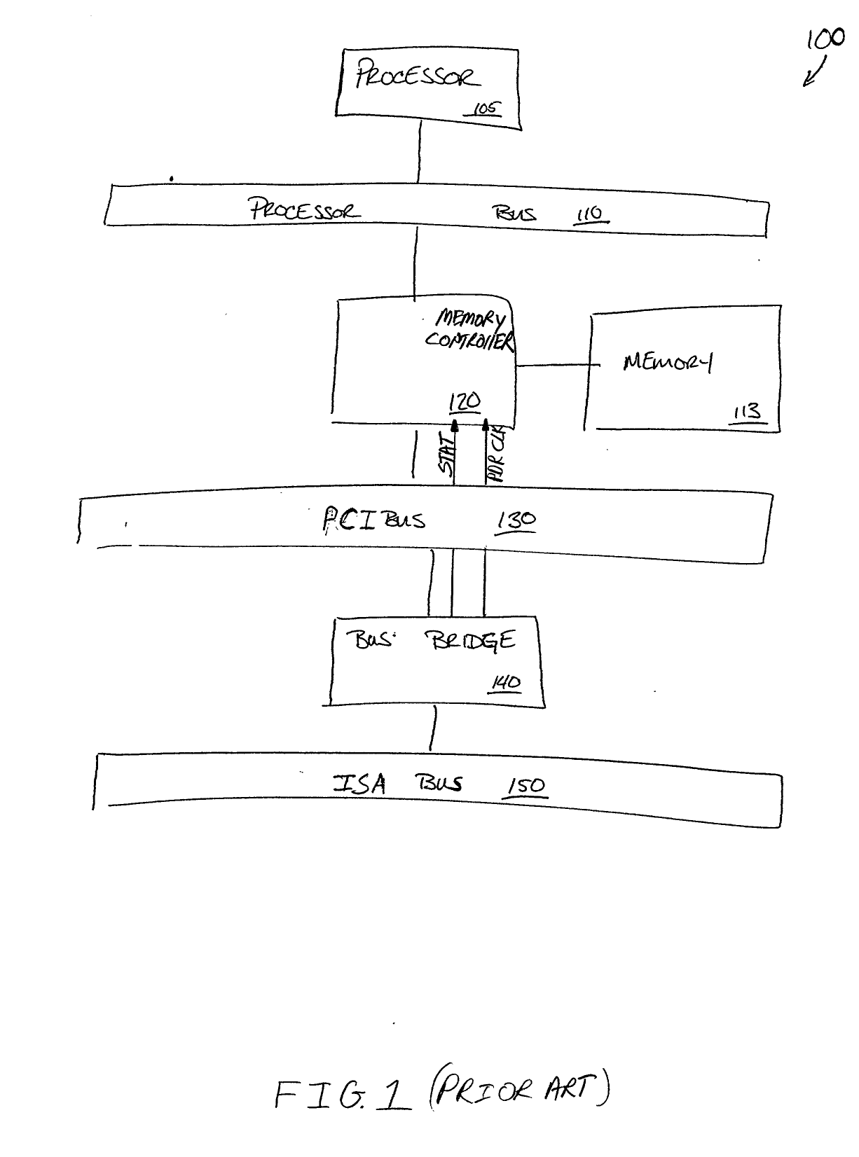

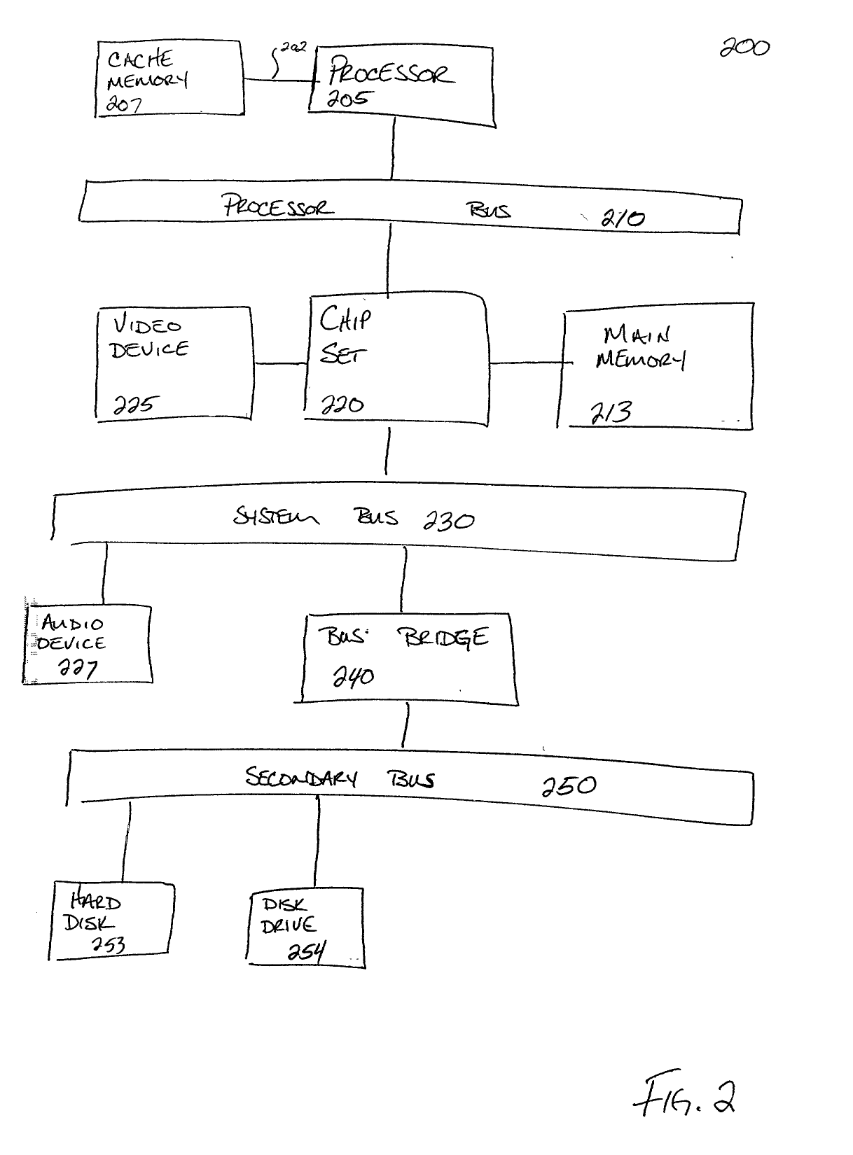

FIG. 2 is a block diagram of one embodiment of a computer system 200. Computer system 200 includes processor 205 coupled to processor bus 210. In one embodiment, processor 205 is a processor in the Pentium® family of processors including the Pentium® II family and mobile Pentium® and Pentium® II processors available from Intel Corporation of Santa Clara, Calif. Alternatively, other processors may be used. Processor 205 may include a first level (L1) cache memory (not shown in FIG. 1).

In one embodiment, processor 205 is also coupled to cache memory 207, which is a second level (L2) cache memory, via dedicated cache bus 202. The L1 and L2 cache memories can also be integrated into a single device. Alternatively, cache memory 207 may be coupled to processor 205 by a shared bus. Cache memory 207 is optional and is not required for computer system 200.

Chip set 220 is also coupled to processor bus 210. In one embodiment, chip set 220 is the 440BX chip set available from Intel Corporation; however, other chip sets can also be used. Chip set 220 may include a memory controller for controlling a main memory 213. Main memory 213 is coupled to processor bus 210 through chip set 220. Main memory 213 and cache memory 207 store sequences of instructions that are executed by processor 205. In one embodiment, main memory 213 includes an extended data out dynamic random access memory (EDO DRAM); however, main memory 213 may have other configurations. The sequences of instructions executed by processor 205 may be retrieved from main memory 213, cache memory 207, or any other storage device. Additional devices may also be coupled to processor bus 210, such as multiple processors and/or multiple main memory devices. Computer system 200 is described in terms of a single processor; however, multiple processors can be coupled to processor bus 210. Video device 225 is also coupled to chip set 220. In one embodiment, video device includes a video monitor such as a cathode ray tube (CRT) or liquid crystal display (LCD) and necessary support circuitry.

Processor bus 210 is coupled to system bus 230 by chip set 225. In one embodiment, system bus 230 is a Peripheral Component Interconnect (PCI) standard bus; however, other bus standards may also be used. Multiple devices, such as audio device 227, may be coupled to system bus 230.

Bus bridge 240 couples system bus 230 to secondary bus 250. In one embodiment, secondary bus 250 is an Industry Standard Architecture (ISA) bus; however, other bus standards may also be used, for example Extended Industry Standard Architecture (EISA). Multiple devices, such as hard disk 253 and disk drive 254 may be coupled to secondary bus 250. Other devices, such as cursor control devices (not shown in FIG. 2), may be coupled to secondary bus 250.

According to one embodiment, computer 200 operates in either a normal mode or a low power mode. Computer system 200 is in the low power mode whenever power is shutdown to most of its subsystems (e.g., processor 205, and video device 225). However, the content of main memory 213 is maintained while computer system 200 is in the low power mode.

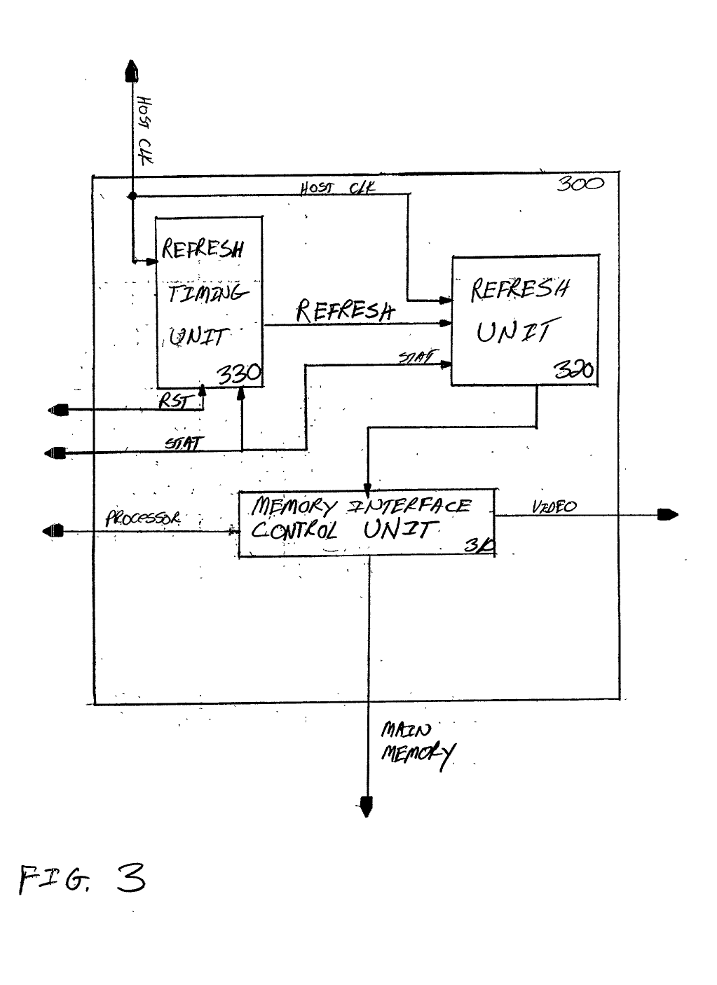

FIG. 3 illustrates a memory controller 300 in accordance with one embodiment of the present invention. Memory controller 300 includes memory interface control unit 310, refresh unit 320 and refresh timing unit 330. Memory controller 300 accesses main memory 213 based upon commands received from processor 205 and one or more peripheral devices such as video device 227 coupled to chip set 220. Memory controller 300 may read data from, and write data to, main memory 213. For some operations such as main memory refresh, memory controller 300 must access all portions of main memory 213 within a deterministic time period. According to one embodiment, memory controller 300 is included within chip set 220.

Memory interface control unit 310 is coupled to refresh unit 320 and refresh timing unit 330. Memory interface control unit 310 coordinates access to main memory 213 by various agents, such as processor 205, video device 225 and refresh unit 320. In addition, memory interface control unit 310 transmits memory cycles to main memory 113. One of ordinary skill in the art will appreciate that other agents or devices may be coupled to memory interface control unit 310 in order to gain access to main memory 213.

Refresh unit 320 is coupled to refresh timing unit 330 and recharges electrical cells within main memory 213 in order to maintain data integrity. Refresh unit receives a REFRESH signal from refresh timing unit 330 in order to trigger a refresh event. Refresh unit 320 also receives a power status signal (STAT) from bus bridge 240. STAT is an indicator of whether computer system 200 is operating in a normal mode or a low power mode. The low power mode of operation enables power conservation whenever computer system 200 is powered up, but has not recently been used. Additionally, refresh unit 230 receives HOST CLK from processor 205.

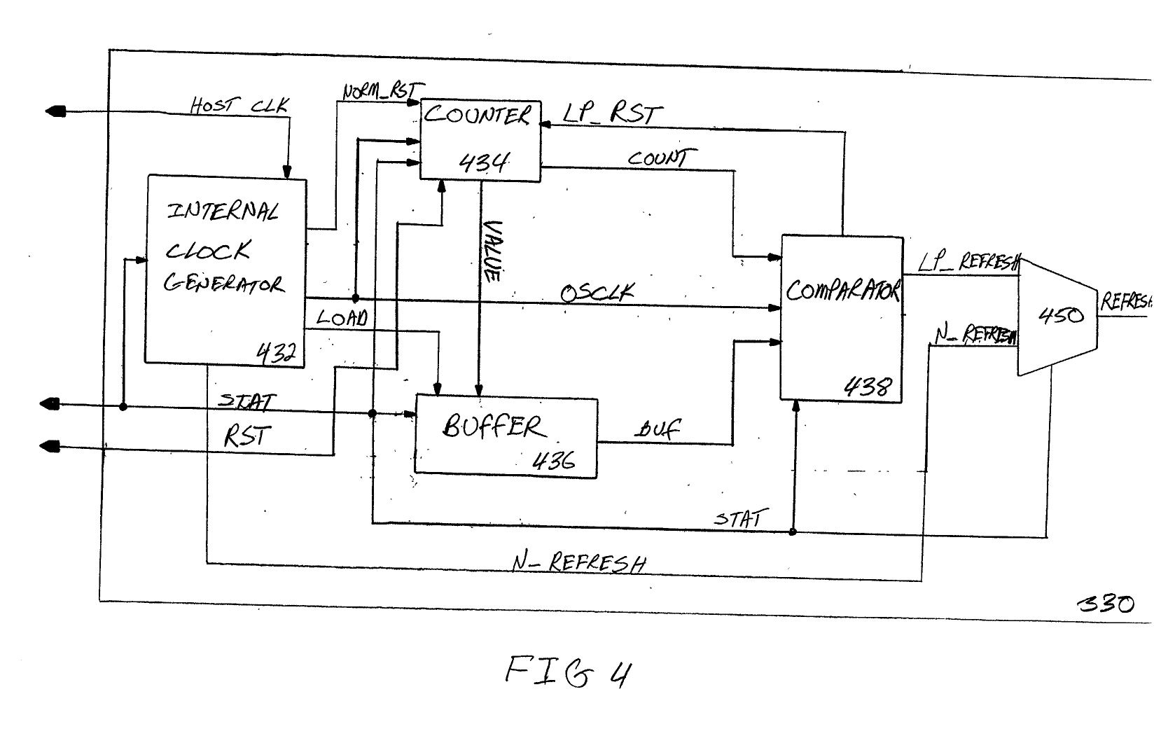

Refresh timing unit 330 also receives the HOST CLK and STAT signals. In addition, refresh timing unit 330 receives a reset signal (RST) that is used to reset circuitry internal to refresh timing unit 330. FIG. 4 is a block diagram of refresh timing unit 330 in accordance with one embodiment of the present invention. Refresh timing unit 330 includes an internal clock generator 432, counter 434, buffer 436, comparator 438 and multiplexer 450.

Refresh timing unit 330 triggers main memory 213 refresh events. Refresh events are triggered based upon HOST CLK whenever computer system 200 is operating in the normal mode. HOST CLK is a timing reference used to generate normal refreshes at repeatable deterministic intervals. According to one embodiment, memory refreshes are triggered every 15.6 microseconds. However, one of ordinary skill in the art will appreciate that refresh cycles may occur at other frequencies. Refresh timing unit 330 also triggers refresh events whenever computer system 200 is operating in the low power mode.

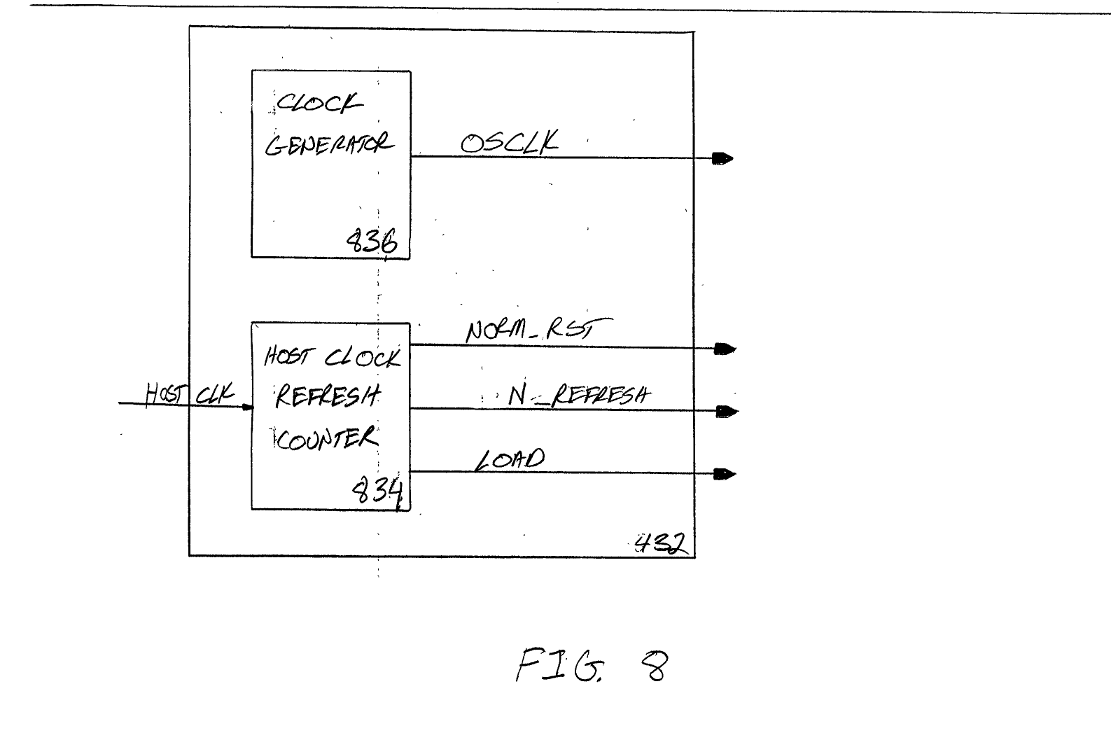

Internal clock generator 432 generates refresh trigger events, both in the normal mode and low power mode. FIG. 8 is a block diagram of internal clock generator 432. Internal clock generator 432 includes a host clock refresh counter 834 and clock generator 836. Host clock refresh counter 834 is a logic block that references the HOST CLK signal in order to generate a refresh trigger (N_REFRESH) whenever computer system 200 is operating in the normal mode. Host clock refresh counter 834 also generates a NORM_RST and LOAD signal. Clock generator 836 generates an oscillating clock signal (OSCLK) that triggers memory refreshes in the low power mode of operation for computer system 200. However, clock generator 836 is active at all times (i.e., in normal mode and low power mode).

According to one embodiment, clock generator 836 is a ring oscillator implemented using a chain of thirty-six (37) serially coupled inverters. The OSCLK signal is generated each time a signal completely propagates through the chain of inverters. One of ordinary skill in the art will appreciate that clock generator 836 may be implemented using other quantities of inverters. Further, other clock generation methods may be used to implement clock generator 836.

Referring back to FIG. 4, counter 434 is coupled to internal clock generator 432 and increments each time an OSCLK pulse is received from clock generator 836. Counter 434 counts the number of OSCLK pulses generated while computer system 200 operating in both the normal and low power modes. Counter 434 also receives the STAT, RST and NORM-RST signals. Counter 434 receives the RST signal for initialization upon system startup. The NORM-RST signal is received at counter 434 in order to provide a reset after each refresh in the normal mode. Additionally, an LP_RST signal is received from comparator 438 after each refresh in low power mode in order to reset counter 434.

Further, counter 434 transmits a COUNT signal to comparator 438 after each increment at times computer system 200 is operating in the low power mode. Counter 434 also transmits a VALUE signal to buffer 436. VALUE represents the number of OSCLK pulses received by counter 434 between normal mode memory refreshes. Buffer 436 is coupled to counter 434 and stores the VALUE signals received from counter 434. Buffer 436 accepts the VALUE signals upon receiving the LOAD signal from host clock refresh counter 834 within internal clock generator 432. LOAD indicates that a normal refresh has been triggered and that new VALUE signals are ready to be transferred to buffer 436.

In addition, buffer 436 transmits a BUF signal to comparator 438 whenever computer system 200 transitions from the normal mode to the low power mode. BUF represents the frequency at which refresh events are to be triggered during low power mode operation. According to one embodiment, buffer 436 is implemented using one or more storage registers. However, one of ordinary skill in the art will appreciate that other memory devices may be used to implement buffer 436.

Comparator 438 is coupled to internal clock generator 432, counter 434, buffer 436 and multiplexer 450. Comparator 438 compares the COUNT signal received from counter 434 with the BUF signal received from buffer 436 while computer system 200 is operating in the low power mode. Once a match is detected between COUNT and BUF, a signal (LP_REFRESH) is transmitted to multiplexer 450. Also, comparator 438 transmits the LP_RST signal to counter 434 upon a match between COUNT and BUF.

Multiplexer 450 selects between the N_REFRESH and LP_REFRESH signals based upon the STAT signal. If STAT indicates that computer system 200 is operating in the normal mode, N_REFRESH is transmitted to refresh unit 320 as REFRESH in order to trigger a memory refresh. However, if STAT indicates that computer system 200 is operating in the low power mode, LP_REFRESH is transmitted as REFRESH.

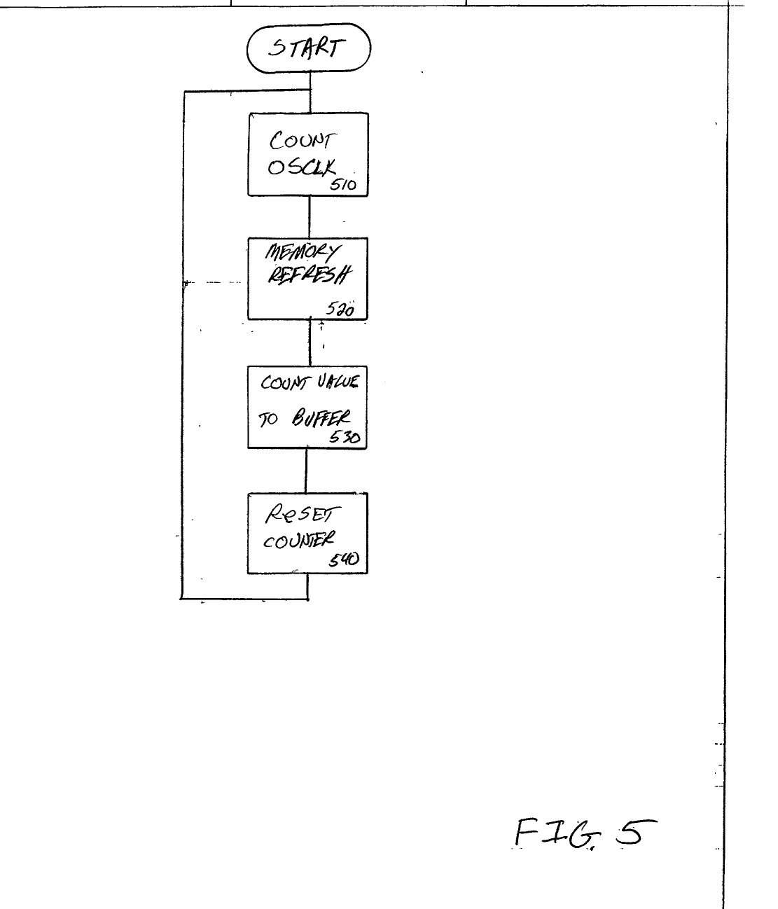

As described above, memory refreshes are triggered based upon a HOST CLK reference whenever computer system 200 is operating in the normal mode. After a normal mode refresh, counter 434 is reset upon receiving the NORM_RST signal. FIG. 5 is a flow diagram of the operation of refresh timing unit 330 while operating in the normal mode. At process block 510, counter 434 commences to count OSCLK pulses generated by clock generator 836. Counter 434 increments upon each received OSCLK pulse. OSCLK pulses are counted until a subsequent memory refresh is triggered by host clock counter 834. Alternatively, as will be described later, counter 434 is interrupted upon receiving the STAT signal indicating a transition into the low power mode.

At process block 520, a subsequent memory refresh is triggered by host clock counter 834. As described above, memory refreshes are triggered every 15.6 microseconds. At process block 530, the incremented count (i.e., the number of OSCLK pulses received by counter 434 between normal refresh cycles) is transmitted to buffer 436 as VALUE. At process block 540, counter 434 is again reset after the refresh, and control is returned to process block 510 wherein counter 434 begins counting OSCLK pulses again. According to one embodiment, the normal mode operation of refresh timing unit 330 is continually repeated in order to periodically update the number of OSCLK pulses that occur during a refresh cycle. Consequently, timing refresh unit continuously tracks of the number of OSCLK pulses that occur between memory refreshes whenever it is operating in the normal mode.

The tracking of OSCLK pulses that occur while computer system 200 is operating in the normal mode is essentially a calibration feature of the present invention. The number of OSCLK transitions that occur between each normal refresh dictates the number of OSCLK pulses that are to be received by counter 434 before triggering a low power mode refresh. However, due to the potential difference of voltage and temperature conditions, or process skew, within computer system 200, operating conditions may vary. Accordingly, the frequency of OSCLK pulses generated by clock generator 836 between normal mode refreshes may vary. Hence, refresh timing unit 330 functions as automatic compensation circuitry that continuously evaluates the time between normal refresh events while computer system 200 is in the normal mode of operation.

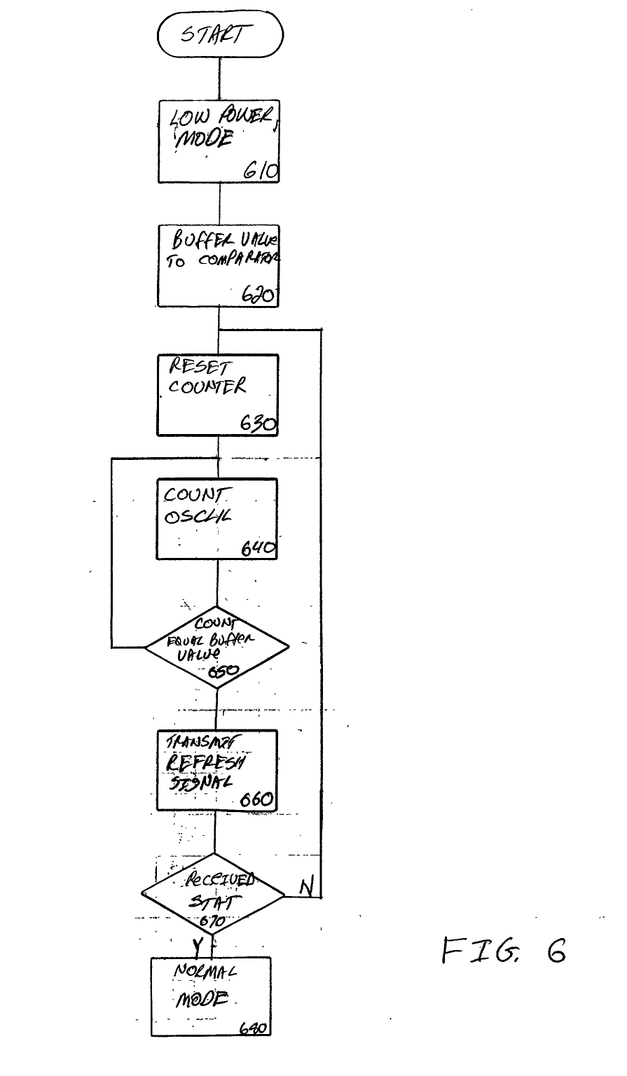

Upon receiving the STAT signal indicating that computer system 200 is transitioning from the normal mode to the low power mode, the function of refresh timing unit 330 switches from calibration circuitry to a refresh trigger. FIG. 6 is a flow diagram of the operation of refresh timing unit 330 while operating in the low power mode. At process block 610, refresh timing unit 330 transitions from the normal mode to the low power mode. At process block 620, buffer 436 transmits BUF to comparator 438. As described above, BUF represents the refresh frequency while operating in the low power mode. At process block 630, comparator 438 transmits the LP_RST which causes counter 434 to reset.

At process block 640, counter 434 begins counting OSCLK pulses received from clock generator 836. As each pulse is received, counter 434 is incremented. Each incremented value is, in turn, transmitted to comparator 438 as COUNT. At process block 650, it is determined whether the COUNT value is equal to the BUF value stored in comparator 438. If it is determined that COUNT is unequal to BUF, control is returned to process block 640 wherein counter receives a subsequent OSCLK pulse. If it is determined that COUNT is equal to BUF, comparator 438 is enabled and transmits the LP_REFRESH signal multiplexer 450. Multiplexer 450, in turn, transmits a REFRESH signal to refresh unit 320. Refresh unit arbitrates and is granted access to main memory 213 wherein a refresh is executed.

At process block 670 it is determined whether the STAT signal has been received, indicating a transition from the low power mode back to the normal mode. If it is determined that the STAT signal has not been received, control is returned back to process block 630 wherein comparator 438 transmits the LP_RST signal and counter 434 is reset. If the STAT signal has been received, refresh timing unit 330 returns to the normal mode of operation, process block 680.

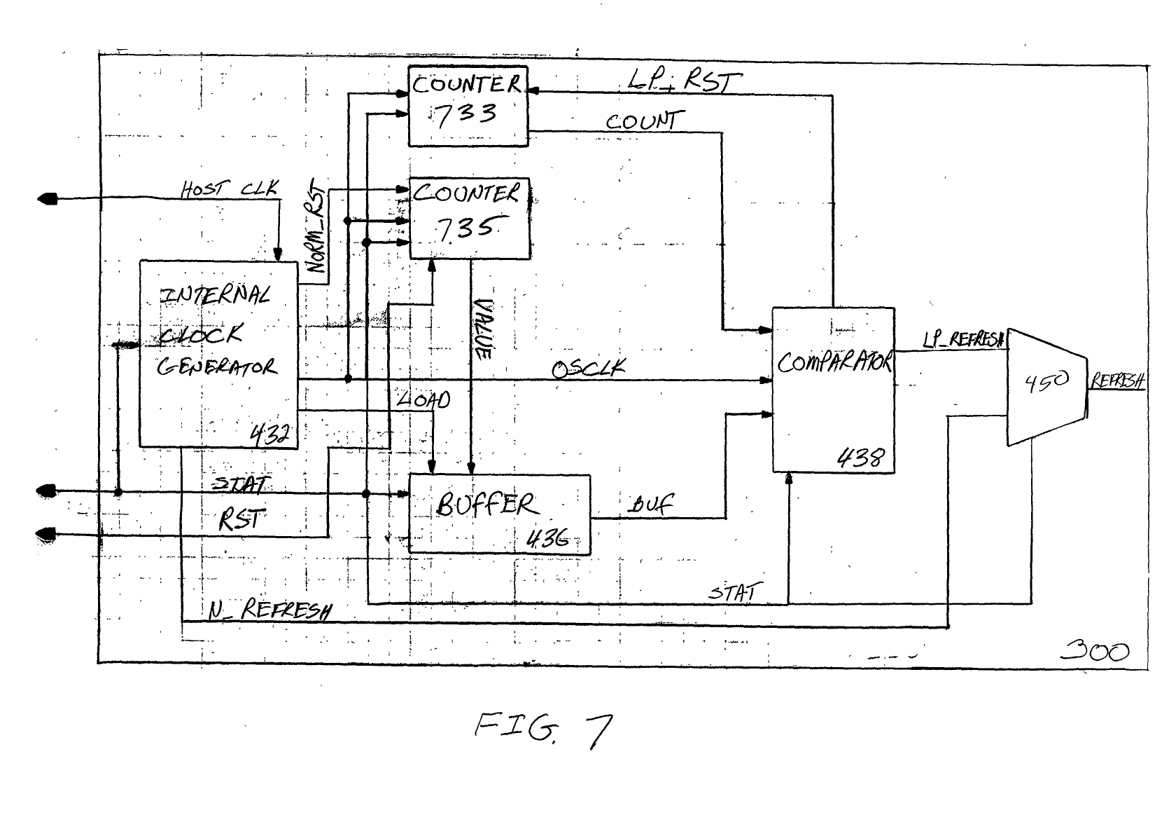

FIG. 7 is a block diagram of another embodiment of refresh timing unit 330 in which the functions of counter 434 is divided between counters 733 and 735. In this embodiment, counter 735 operates while computer system 200 is in the normal mode and counter 733 operates while computer system 200 is in the low power mode. Counter 735 is coupled to internal clock generator 432 and buffer 436, and counts OSCLK pulses generated by clock generator 836 between normal mode memory refreshes. Additionally, counter 735 transmits VALUE upon buffer 436 receipt of the LOAD signal indicating a refresh event.

Upon receiving the STAT signal indicating a transition to the low power mode, counter 735 is deactivated and counter 733 is activated. Subsequently, counter 733 begins counting OSCLK pulses and transmitting the incremented COUNT values to comparator 438. Upon a transition from the low power mode back to the normal mode, counter 733 is deactivated and counter 735 is again activated.

Thus, a method and apparatus providing a memory controller with an internal clock source for triggering a memory refresh has been described

What is claimed is:

1. A computer system comprising:
a memory; and
a memory controller, wherein the memory controller includes a refresh timing circuit for generating clock pulses used to trigger memory refresh events.

2. The computer system of claim 1, wherein the refresh timing circuit triggers memory refresh events whenever the computer system is operating in a normal mode and a low power mode.

3. The computer system of claim 2, wherein the refresh timing circuit further comprises:
a clock generator for generating the clock pulses;
a first counter coupled to the clock generator;
a storage register coupled to the clock generator and the counter; and
a comparator coupled to the clock generator, the counter and the storage register.

4. The computer system of claim 3, wherein the first counter counts the number of clock pulses generated by the clock generator.

5. The computer system of claim 4, wherein the first counter transmits data to the storage register whenever the computer system is operating in the normal mode, the data representing the number of clock pulses counted by the counter since the occurrence of a prior memory refresh event.

6. The computer system of claim 5, wherein the storage register transmits the data to the comparator upon a transition from the normal mode to the low power mode.

7. The computer system of claim 6, wherein the first counter transmits signals to the comparator whenever the computer system is operating in the low power mode, the signal representing the number of clock pulses received from the clock generator.

8. The computer system of claim 7, wherein the comparator compares the signal received from the first counter and the data received from the storage register, and wherein the comparator transmits a refresh trigger signal whenever there is a match between the signal and the data.

9. The computer system of claim 4, wherein the refresh timing circuit further comprises a second counter.

10. The computer system of claim 9, wherein the first counter counts the number of clock pulses generated by the clock generator while the computer system is operating in the low power mode and the second counter counts the number of clock pulses generated by the clock generator while the computer system is operating in a normal mode.

11. The computer system of claim 10, wherein the second counter transmits data to the storage register upon the occurrence of a memory refresh event whenever the computer system is operating in the normal mode, the data representing the number of clock pulses counted by the counter since the occurrence of a previous memory refresh event.

12. The computer system of claim 11, wherein the second counter is deactivated and the first counter is activated whenever the computer system transitions from the normal mode to the low power mode.

13. The computer system of claim 12, wherein the first counter transmits signals to the comparator whenever the computer system is operating in the low power mode, the signal representing the number of clock pulses received from the clock generator.

14. The computer system of claim 3, wherein the refresh timing circuit includes a second counter for triggering memory refresh events whenever the computer system is operating in the normal mode

15. The computer system of claim 1, wherein the memory is an Extended Data Out Dynamic Random Access Memory (EDO DRAM) and the memory controller is an EDO DRAM controller.

16. An Extended Data Out Dynamic Random Access Memory (EDO DRAM) controller comprising:
a refresh timing circuit for generating clock pulses used to trigger memory refresh events.

17. The computer system of claim 16, wherein the refresh timing circuit further comprises:
a clock generator;
a first counter coupled to the clock generator;
a storage register coupled to the clock generator and the counter; and
a comparator coupled to the clock generator, the counter and the storage register.

18. The EDO DRAM controller of claim 17, wherein the EDO DRAM controller operates in a normal mode and a low power mode.

19. The EDO DRAM controller of claim 18, wherein the first counter counts the number of clock pulses generated by the clock generator.

20. The EDO DRAM controller of claim 19, wherein the first counter transmits data to the storage register whenever the EDO DRAM controller is operating in the normal mode, the data representing the number of clock pulses counted by the counter since the occurrence of a previous memory refresh event.

21. The EDO DRAM controller of claim 20, wherein the storage register transmits the data to the comparator upon a transition from the normal mode to the low power mode.

22. The EDO DRAM controller of claim 21, wherein the first counter transmits signals to the comparator whenever the EDO DRAM controller is operating in the low power mode, the signal representing the number of clock pulses received from the clock generator.

23. The EDO DRAM controller of claim 22, wherein the comparator compares the signal received from the first counter and the data received from the storage register, and wherein the comparator transmits a refresh trigger signal whenever there is a match between the signal and the data.

24. The EDO DRAM controller of claim 19, wherein the refresh timing circuit further comprises a second counter.

25. The EDO DRAM controller of claim 24, wherein the first counter counts the number of clock pulses generated by the clock generator while the EDO DRAM controller is operating in the low power mode and the second counter counts the number of clock pulses generated by the clock generator while the EDO DRAM controller is operating in the normal mode.

26. The EDO DRAM controller of claim 25, wherein the second counter transmits data to the storage register upon the occurrence of a memory refresh event whenever the EDO DRAM controller is operating in the normal mode, the data representing the number of clock pulses counted by the counter since the occurrence of a previous memory refresh event.

27. The EDO DRAM controller of claim 26, wherein the second counter is deactivated and the first counter is activated whenever the EDO DRAM controller transitions from the normal mode to the low power mode.

28. The EDO DRAM controller of claim 27, wherein the first counter transmits signals to the comparator whenever the EDO DRAM controller is operating in the low power mode, the signal representing the number of clock pulses received from the clock generator.

29. A method of calibrating a refresh timer in a computer system, the method comprising:
counting a first set of clock pulses received at a counter from a clock generator;
receiving a signal indicating that a memory refresh event has been triggered; and
storing a first count representing the number of clock cycles received at the counter before receiving the signal.

30. The method of claim 29, further comprising:
resetting the counter after storing the first count;
counting a second set of clock pulses;
receiving the signal indicating that a memory refresh event has been triggered; and
storing a second count.

31. The method of claim 29, wherein the refresh timer is a low power mode refresh timer.

32. In a computer system having a normal mode of operation and a low power mode of operation, a method of triggering a memory refresh event while the computer system is operating in the low power mode, the method comprising:
transmitting a frequency value to a comparator, the frequency value representing the frequency at which to trigger memory refresh events;
transmitting a first clock pulse count to the comparator;
determining whether the first clock pulse count is equal to the frequency value; and
transmitting a first refresh signal.

33. The method of claim 32, further comprising:
transmitting a second clock pulse count to the comparator if it is determined that the first clock pulse is not equal to the frequency value;
determining whether the second clock pulse count is equal to the frequency value; and
transmitting the first refresh signal.

34. The method of claim 32, further comprising transitioning from the normal mode of operation to the low power mode of operation before transmitting the frequency value to the comparator.

35. The method of claim 32, wherein the process of transmitting the first clock pulse count to the comparator further comprises:
transmitting a clock pulse from a clock generator to a counter;
incrementing the counter; and
transmitting the incremented count to the comparator.

36. The method of claim 35, further comprising resetting the counter before transmitting the clock pulse from the clock generator.

37. The method of claim 35, further comprising:
resetting the counter after transmitting the refresh signal;
transmitting a second clock pulse count to the comparator;
determining whether the second clock pulse count is equal to the frequency value; and
transmitting a second refresh signal.
